(19) United States
(12) Patent Application Publication
(10) Pub. No.: US 2020/0334751 A1
(43) Pub. Date: Oct. 22, 2020

(54) SYSTEMS AND METHODS FOR ADDITIONAL RENEWABLE CAPACITY CREDITS

(71) Applicant: OGE Energy Corp., Oklahoma City, OK (US)

(72) Inventors: Kevin Lagge, Edmond, OK (US); Michael D. Ballard, Edmond, OK (US); Kandace Smith, Midwest City, OK (US)

(73) Assignee: OGE Energy Corp., Oklahoma City, OK (US)

(21) Appl. No.: 16/847,769

(22) Filed: Apr. 14, 2020

Related U.S. Application Data
(60) Provisional application No. 62/835,837, filed on Apr. 18, 2019.

(51) Int. Cl. G06Q 40/04; G06F 16/27; G06Q 50/06; G06Q 30/00; G06Q 50/00

(52) U.S. Cl. CPC G06Q 40/04; G06F 16/27; G06Q 50/01; G06Q 30/018; G06Q 50/06

(57) ABSTRACT

Systems and methods are described herein for generating and/or providing additional renewable capacity credits relating to energy capacity of a renewable energy source. An example method includes converting the energy capacity of the renewable energy source into one or more additional renewable capacity credits and providing the additional renewable capacity credits to offset energy consumption for a particular energy-consuming device, location, or process.

### CROSS-REFERENCE TO RELATED APPLICATION

This application claims priority from U.S. Provisional Patent Application No. 62/835,837 filed Apr. 18, 2019, the contents of all of which are incorporated herein by reference in their entirety.

### TECHNICAL FIELD

The technology described herein relates generally to the creation, tracking and assignment of environmental credits that link additional renewable energy assets to a particular energy-consuming product, service, facility, or process.

### BACKGROUND

Commodity markets have been developed to provide tradeable certificates, commonly referred to as “credits,” based on generation and use of renewable energy. For example, two types of existing renewable energy certificates are renewable energy credits and carbon credits. A renewable energy credit is a tradable certificate that is based on the generation of power by a renewable energy source, such as wind or solar. For instance, when power is generated by a renewable energy source and sold into the local power grid, the renewable energy provider may also sell renewable energy credits as a commodity into the marketplace that are linked to the generated renewable energy. Typically, a renewable energy credit represents one megawatt hour (MWh) of generated renewable energy. A customer purchasing a renewable energy credit may then be able to claim the equivalent of one MWh of energy reduction in greenhouse gas emissions as an offset to conventional energy use. A carbon credit, on the other hand, is a tradeable certificate that typically represents the right to emit a certain amount (e.g., one metric ton) of carbon dioxide or other greenhouse gas. Carbon credits have been used as a component of government regulation capping greenhouse gas emissions.

### SUMMARY

Systems and methods are described herein for generating and/or providing additional renewable capacity credits relating to energy capacity of a renewable energy source. An example method includes converting the energy capacity of the renewable energy source into one or more additional renewable capacity credits and providing the additional renewable capacity credits to offset energy consumption for a particular energy-consuming device, location, or process.

### BRIEF DESCRIPTION OF THE FIGURES

FIG. 1 is a diagram illustrating an example process with an additional renewable capacity credit (“ARCC”).

FIG. 2 is a diagram depicting an example of an ARCC model

FIG. 3 is a flow diagram of an example ARCC process.

FIG. 4 depicts an example method of matching an ARCC with a specified device.

FIG. 5 depicts an example use case for ARCCs.

FIGS. 6-7 are diagrams depicting example elements and operations of a computer-implemented application for creating, tracking, and assigning ARCCs.

FIGS. 8-14 further illustrate example elements and operations of a computer-implemented application (s) for creating, tracking, assigning, advertising, promoting, and gamifying ARCCs.

FIG. 15 is a block diagram of an example system for providing a computer-based (e.g., online) market where additional renewable capacity credits may be provisioned, bought, sold, and traded (referred to herein as an ARCC system).

### DETAILED DESCRIPTION

The systems and methods described herein may be used to provide a computer-based (e.g., online) market where additional renewable capacity credits may be provisioned, bought, sold, and traded. As detailed below, an additional renewable capacity credit is an electronic certificate (i.e., credit) that is associated with the addition of renewable energy capacity to support the operation of a particular energy-consuming product (e.g., electronic device), service, facility, or process.

FIG. 1 is a diagram illustrating an example process with an additional renewable capacity credit (“ARCC”). As illustrated, an ARCC 20 is linked to the installation of a renewable energy generation source, such as a solar panel 10 or wind turbine (not depicted). The energy-generating capacity of an installed renewable energy generation source, such as a solar panel 10, is converted from units of energy capacity (e.g., watts of capacity) to ARCCs 20, for example with one watt equaling one ARCC 20. The particular ARCC 20 or ARCCs 20 are generated (e.g., tokenized) into the market, for example using block-chain technology 30. For example, block-chain technology 30 may be used to verify to a user 40 or other entity that each ARCC 20 is traceable to a watt of additional renewable energy capacity and that the energy reduced is traceable to renewable energy production and greenhouse gas reduction.

Block-chain technology 30 may also be used to enable the ARCC owner or user 40 (e.g., the user of a particular device associated with the ARCC) to track the renewable energy output associated with their ARCC 20, or to sell or trade the ARCC 20. In one example, an ARCC owner 40 may be able to trade the ARCC 20 for a special functionality or operation on an associated device (e.g., a special ringtone for a cell phone.) In certain examples, the ARCC owner 40 may able to track and manage ARCCs 20 with a software application, for instance a software application executing on a device associated with the ARCC 20.

Block-chain technology 30 may also be used in connection with a verification service, such as the Green-e® service provided by the Center for Resource Solutions, in order to authenticate and validate ARCCs 20 placed into the market. For example, block-chain technology 30 may be used to certify that an ARCC sold into the market is traceable to a set amount of additional renewable energy capacity produced by a particular energy generation source (such as a particular solar panel 10). A verification service, such as the Green-e® service, may then be used to verify that the particular solar panel 10 continues to operate and generate the amount of additional renewable energy capacity associated with the ARCC 20. The user 40 can then, for example, track the renewable energy output associated with their ARCC 20, can see pictures of the corresponding renewable energy source, can trade their tokens or turn them into particular operations on their device.

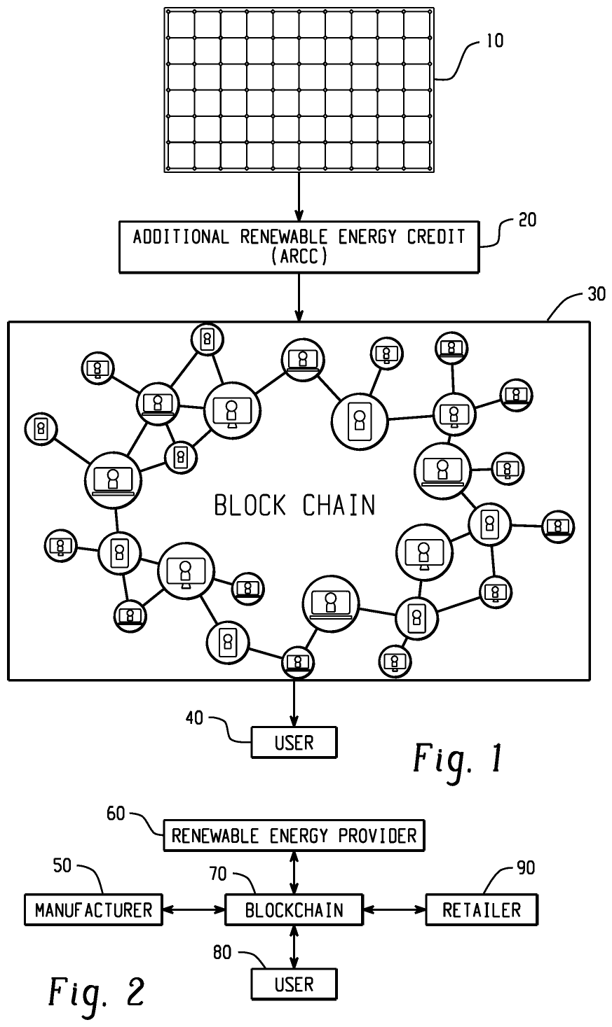

FIG. 2 is a diagram depicting an example of an ARCC model. As shown in FIG. 2, an example ARCC model may include interactions between a renewable energy provider 60, a manufacturer 50, a retailer 90, and a device owner or user 80 (e.g., a consumer) utilizing block-chain technology 70. The example ARCC marketplace is an online market where ARCCs 20 may be provisioned, bought, sold, and/or traded. For instance, users 80 and companies 50, 90 alike may utilize the ARCC marketplace to acquire and assign ARCCs 20 to electronic devices, facilities, process, and consumer goods, in the marketplace. An ARCC 20 is created when a renewable energy provider 60 installs, certifies and operates a renewable generation asset that is converted into ARCCs 20. Each watt of capacity becomes an ARCC 20 and each ARCC 20 will become a token\security\credit in the marketplace. The ARCC 20 may, for example, be a contract right, having the form and appearance of a renewable portfolio standard or carbon credit.

In embodiments, ARCCs 20 may be offered for new electronic devices. In other embodiments, however, ARCCs 20 may be offered for other assets, such as facilities, manufacturing or agriculture processes, consumer goods, etc. Companies such as retailers 90 or manufacturers 50 may, for example, buy and provision ARCCs 20 for the products they sell, then transfer the ownership to the buyers or users 80 of their products. As another example, companies 50, 90 may sell ARCCs 20 to users 80 when a product is sold. Users 80 may also be able to buy ARCCs 20 for devices they are purchasing, for their homes, to be given as gifts, etc. In other examples, companies 50, 90 and governments may purchase ARCCs 20 for their operations, devices, facilities or processes.

The ARCC marketplace may, for example, include community operations where ARCC owners 40, manufacturers 50, community governments, and/or retailers 90 can communicate their sustainability goals and status (e.g., number of tokens), as well as recruit other members to the marketplace. In certain examples, the marketplace may be gamified. For instance, a user may have the ability to receive rewards (e.g., ringtones, screensavers, etc.) based on their ranking on a sustainability scoreboard (score card includes number or tokens, etc.). In embodiments, a user 80 may receive rarer and rarer awards as their ranking on a sustainability scoreboard and/or number of owned ARCCs 20 increases.

The renewable energy provider 60 may install and operate generation assets that will be converted into ARCCs 20. The renewable energy provider 60 may provide the market with the ARCC 20 price, capacity value, energy production, and greenhouse gas (GHG) offset for each ARCC 20. The renewable energy provider 60 may also certify through an independent source that the capacity, energy production & GHG offsets are valid and meet the additionality (additionality: new renewable assets added to the grid for each transaction) requirement of the market. The energy provider 60 may be accountable for security, maintenance and performance of the assets in order to meet ARCC product standards and certification. The generation assets may be prebuilt in order to be certified before being offered to the market. If desired, the Retailers 90 or Manufacturers 50 could preorder ARCCs 20 to meet their marketing and sales plans in order to have certified ARCCs 20 available for sale or provisioning.

In one example, the retailer 90 may use retail store locations to sell the ARCC 20 product. The retailer may also provide the ARCC product marketing, which, for example, may focus on the customer's need to contribute to the sustainability of the planet by adding renewable energy one device at a time. The retailer 90 may sell the ARCC 20 to the customer at the time of the electronic device purchase, for example as an add-on feature to the device. Each ARCC 20 sold by the retailer 90 may, for example, be branded with the retailer's marketing collateral in the marketplace and user app. In embodiments, the cost to the user 80 may be a nominal amount compared to the associated product and the ARCC 20 may, for example, be sold as a one-time charge or a recurring $/month over the life of the contract.

In another example, the retailer 90 may purchase the ARCC 20 through the marketplace. The retailer may provision the ARCC 20 to the device at the time of sale. The retailer 90 may also provide the ARCC 20 product marketing which, for example, may focus on how the retailer 90 is contributing to the sustainability of the planet by adding renewable energy one device at a time. For instance, the retailer 90 may market in the store and as part of their sustainability marketing plan. In certain examples, the retailer 90 may have the option to pre-purchase ARCCs 20 from the renewable energy provider 60 to ensure supply and cost. Each ARCC 20 provisioned by the retailer 90 may, for example, be branded with the retailer's marketing collateral in the marketplace and user app. In embodiments, there may be no cost to the user 80 because the value of the ARCC 20 is provided to the retailer 90 in the marketing of their sustainability position.

The device manufacture 50 (or, in embodiments the facility, process, consumer good, or other energy-consuming asset associated with an ARCC 20) may provide the serial number and energy consumption for each device.

In one example, the manufacturer may purchase the ARCC 20 from the renewable energy provider 60 and provision the ARCC 20 to the device at the time it is sold to the retailer 90. The manufacturer 50 may provide ARCC product marketing which, for example, may focus on how the manufacturer 50 is contributing to the sustainability of the planet by adding renewable energy one device at a time. The retailer 90 may participate with the manufacturer 50 for marketing, for example according to an agreement between the retailer 90 and manufacturer 50. The manufacturer 50 may have the option to pre-purchase ARCCs 20 from the renewable energy provider 60 to ensure supply and cost. Each ARCC 20 provisioned by the manufacturer 50 may, for example, be branded with the manufacturer's marketing collateral in the marketplace and user app. In embodiments, there may be no cost to the user 80 because the value of the ARCC 20 is provided to the manufacturer 50 in the marketing of their sustainability position.

In another example, the retailer 90 and the device manufacturer 50 may work together to share some part of the marketing, provisioning or selling of the ARCC 20. This could vary based on the retailer 90 and manufacturer 50 agreements.

In certain examples, the device owner or user 80 may have the ability to view their renewable energy asset through a user app, for example operating on the device associated with the ARCC 20. The device owner 80 may, for example, use the app to see the production of the asset and track the reduction in GHG that they are contributing to the planet. The user 80 may also be provided notifications and screen savers associated with their ARCC's 20 energy production and GHG offsets. In this way, the device owner 80 may become the greatest advocate for using ARCCs 20 to reduce GHG through their willingness to share their sustainability story with others. The user 80 may also have the ability to join a community where goals are set, challenges give, ARCC(s) 20 are bought and sold, and messages are exchanged.

The generation marketplace is an online location where renewable energy providers 60 can bid to provide ARCCs 20 for the ARCC marketplace from locations throughout the world. Renewable energy providers 60 may bid on new renewable generation, for example with price, location, GHG emission reductions, timing, certification and availability.

The marketplaces may have a transaction fee that may, for example, be used to provide revenue for the marketplace owner to provide maintenance, upgrades, etc.

In certain embodiments, a user app installed on the user's 80 electronic device of choice may provide access to the renewable asset information, ARCC marketplace (buying, selling and trading ARCC tokens, ARCC community), rewards (e.g.—screensavers, ringtones), community information, goals, etc.

Renewable energy providers 60, retailers 90, and manufacturers 50 may, in certain examples, access reports on how many ARCCs 20 they have sold or provisioned for marketing and sustainability reporting.

In one example, the number of ARCC tokens to be purchased or provisioned may be determined by the energy consumption of the electronic device sold. The ARCCs 20 may, for example, be assigned to the device through the serial number at the time of sale to the end user 80 or the retailer 90 depending on the use case. As devices end their useful lives, the ARCC 20 may, for example, become available for the device owner 80 to trade or retire in the marketplace.

In certain examples, the number of ARCC tokens to be purchased or provisioned may be determined by the energy consumption of the process. The ARCCs 20 may, for example, be assigned to the process based on the process name and energy consumption.

In embodiments, the number of ARCC tokens to be purchased or provisioned may be determined by the energy consumption of the facility. The ARCCs 20 may, for example, be assigned to the device through electricity demand of the facility.

In certain examples, the number of ARCC tokens to be purchased or provisioned may be determined by the energy consumption needed to produce the good or the amount of energy in the good.

The ARCC 20 may, in certain examples, provide a contract right that will have the form and appearance of a renewable portfolio standard or carbon credit.

In other embodiments, the ARCC 20 may offer the ARCC owner the value (or part of the value) of the energy (sales of the physical energy into the grid) that the ARCC 20 produces. This cost may, for example, be captured in the market and reported from the renewable energy provider 60. This option may, for example, require a higher upfront cost for the ARCC 20 from the renewable energy provider 60 but give the ARCC 20 more long-term value to the consumer.

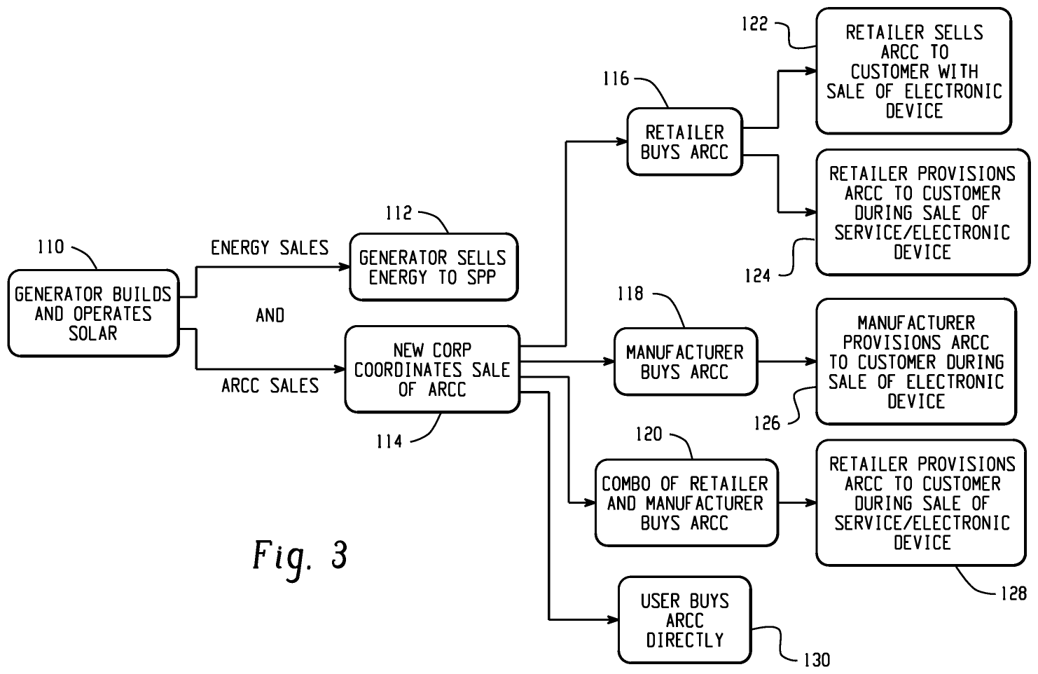

FIG. 3 is a flow diagram of an example ARCC process. At step 110, the renewable energy provider builds and operates a renewable energy power source, such as a wind turbine or solar panel. At step 112, the generated energy is sold into the energy grid. In addition to the sale of generated energy, starting at step 114, the renewable energy provider may also sell ARCCs into the market based on the energy capacity added by the renewable energy power source. This can be done by an entity that coordinates the sale of ARCCs into the market. As illustrated, ARCCs may be purchased in the market by various different entities, such as retailers (step 116), manufacturers (step 118), retailer/manufacture combinations (step 120), and users directly (step 130). A retailer purchasing ARCCs in the marketplace may, for example, sell existing ARCCs to customers with the sale of an associated product or service (step 122) or provision ARCCs for a customer during the sale of an associated product or service (step 124). At step 126, a manufacture purchasing ARCCs in the marketplace may, for example, provision ARCCs to customers during the sale of an associated product or service. At step 128, a retailer/manufacture combination purchasing ARCCs in the marketplace may, for example, provision ARCCs to customers during the sale of the associated product or service.

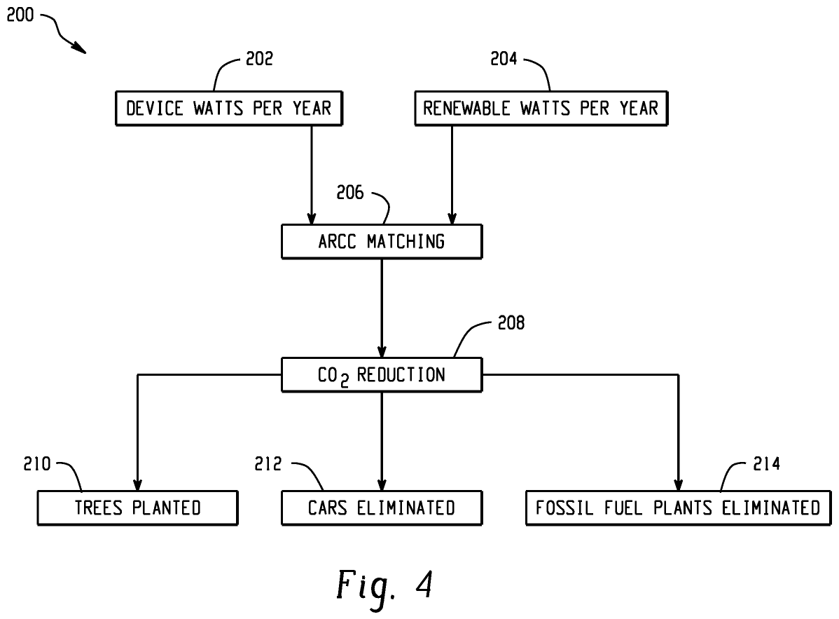

FIG. 4 depicts an example method 200 of matching an ARCC with a specified device. At step 202, the energy requirement over a certain period of time (e.g., yearly energy (kWh)) is calculated for a particular energy-consuming product (e.g., electronic device), facility, service, or process, and is converted into the capacity (e.g., watts) needed to operate the product, facility, or process. For instance, in one example, the yearly energy (kWh) requirements may be calculated for a user device (e.g., a cell phone), and converted into the watts of energy capacity needed to operate the device for one year (kWh/yr). At step 204, the energy-generating capacity of an installed renewable energy generation source, such as a solar panel or wind turbine, is translated from units of energy capacity (e.g., watts of capacity) to ARCCs, for example with one watt equaling one ARCC.

By way of example, a solar panel may have a solar efficiency of 30%. The solar efficiency may be higher or lower depending on the chemistry of the particular solar cell(s), location, orientation, proximity to other objects, weather, and whether the panel incorporates solar tracking, among other factors. The solar watts per year for the exemplary solar panel can be calculated by taking the kilowatt hours per year of the solar panel and dividing by the solar efficiency multiplied by the hours per year of sunlight. The amount of watts per year of the renewable energy generator can then equal one ARCC. As another example, a wind turbine typically produces an output between 15-40% of its rated capacity. This efficiency factor can increase or decrease based on location, weather, wind speed, and wind consistency, among other things. The yearly output of a wind turbine can be calculated by taking the rated amount of kilowatt hours per year for the wind turbine and multiplying it by the efficiency factor. The yearly output can then equal the amount of ARCCs produced by the wind turbine. The ARCC production can be calculated based on estimated energy output in one year, or may reflect historical data from that particular energy source, or a type of average from energy sources in that area.

The number of ARCCs may also be calculated for any type of renewable energy source, or any other energy source, not just wind or solar. For example, ARCCs may be calculated from hydroelectric, geothermal, tidal, hydrogen, or biomass energy sources. Additionally, ARCCs may be calculated from energy capacity of grid-level energy storage installations, such as batteries, electric vehicles, flywheels, hydrogen, hydroelectricity, among others.

At step 206, the particular product, facility, service, or process is matched with the appropriate number of ARCCs to power the product, facility, service, or process for a period of time (e.g. the device's lifetime), and those ARCCs are generated (e.g., tokenized) into the market, for example using block-chain technology. As described above, for example, block-chain technology may be used to verify to a user that each ARCC is traceable to a watt of additional renewable energy capacity and that the energy reduced is traceable to greenhouse gases. At step 208, the number of matched ARCCs can be represented as an amount of CO₂ reduction. For example, each kilowatt hour produced by a fossil fuel plant in the United States is approximately 0.4759 kg of CO₂. This amount will increase or decrease based on various operating factors, but for sake of example, the number of kilowatt hours per year can be converted into kilograms of CO₂ reduction by multiplying the number of kilowatt hours per year by 0.4759.

At step 210, the amount of CO₂ reduction can be converted into an equivalent number of trees planted. The number of trees planted can be represented in the number of young trees or mature trees. As an example, one mature tree can be equal to 22 kgCO₂ and a young tree can be equal to 13 kgCO₂.

At step 212, the amount of CO₂ reduction can then be converted into an equivalent amount of cars or vehicles eliminated. As an example, on average one car is equal to 5050 kgCO₂. Thus, the number of cars eliminated can be calculated by dividing the number of kgCO₂ reduced by 5050. At step 214, the amount of CO₂ reduction can be converted into an equivalent number of fossil fuel plants eliminated. This can be found by dividing the number of kgCO₂ saved by the amount of kgCO₂ produced by an average fossil fuel plant.

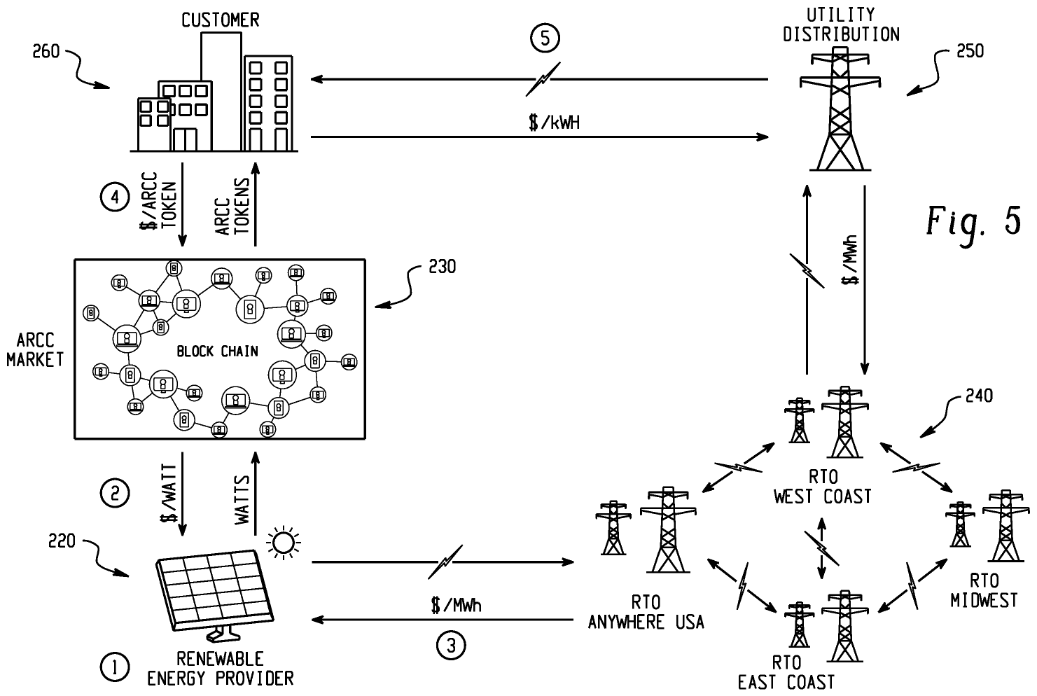

FIG. 5 depicts an example use case for ARCCs. In the illustrated example, a renewable energy provider 220 installs renewable energy capacity (such as a new solar panel) at step 1. The renewable energy provider 220 then sells units (e.g., Watts) of the renewable energy capacity to customers through a block-chain based ARCC marketplace 230 at step 2. During this step, units (e.g., watts) of renewable energy capacity are converted into ARCC tokens in the block-chain based market 230. In addition, the renewable energy provider 220 sells generated energy into the energy grid (e.g., Regional Transmission Organization (“RTO”)) 240 or local utility company at step 3. The user or customer 260 then purchases ARCC tokens through the ARCC market 230 at step 4. Customers 260 may, for example, purchase a number of ARCC tokens that is equivalent to the capacity needed to power the customers energy-consuming device, process, or business for a certain period of time (e.g., for the anticipated operational life of the device). In addition, the customer 260 may purchase energy from the local utility company 250 at step 5, but with the added piece of mind that they have contributed to the addition of renewable energy capacity.

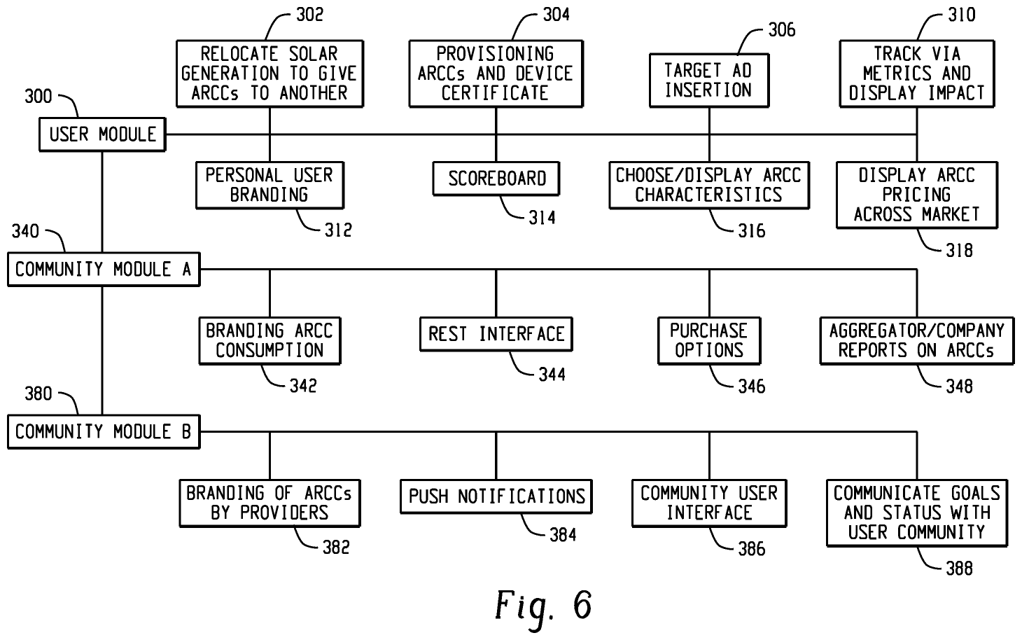

FIG. 6 is diagram depicting example elements and operations of a computer-implemented application(s) for creating, tracking, and assigning ARCCs. The elements and operations depicted in FIG. 6 may, for example, be included in a computer-implemented user interface application. The computer-implemented application(s) may, for example, include software executing on a special-purpose computer or device (such as a smart phone.) As illustrated in FIG. 6, some or all of the depicted application operations may be directed to different system entities, such as a user, depicted in the user module 300, of an electronic device associated with one or more ARCCs, or the community, depicted in the community modules 340, 380, which can be cities, companies, organizations, or other entities. In embodiments, different ARCC operations or user interfaces may be provided for each of these interested entities, with each different interface including some or all of the depicted elements and operations. For instance, in some embodiments, the application or user interface may be customized for a particular entity with a subset of the depicted elements and operations (and/or additional elements and operations). While each operation is depicted in a particular module, each operation may be configured for use in alternate modules as well.

Operation 302 provides an option for providing the ability to gift ARCCs, donate ARCCs, buy ARCCs on behalf of another, relocate solar generation to give a person ARCCs, or perform other related transactions. For example, UI users may have the ability to gift, donate or purchase ARCCs on behalf of other individuals, communities or organizations. (See, e.g., FIG. 11).

Operation 304 provides an option for using the application to provision ARCCs and obtain a device certificate and/or to display device provisioning and device certification details. The application may, for example, provide visibility to the ARCC certification details and the assignment to a particular device. Operation 304 may also provision ARCCs by allocating previously purchased ARCCs by a company to a user's electronic device, facility, product or process. Provisioning may, for example, be done with computer-implemented process that equates the energy used by the electronic device, facility, product or process and equates it into renewable capacity needed to power that assigned electronic device, facility, product or process.

Operation 306 provides an option for targeted ad insertion. Targeted ad insertion may, for example, provide the ability for the ARCC provisioner, device manufacturer, community, or other organization to target the user with messages, and/or to promote their brand, promote goals, offer products, make announcements, etc.

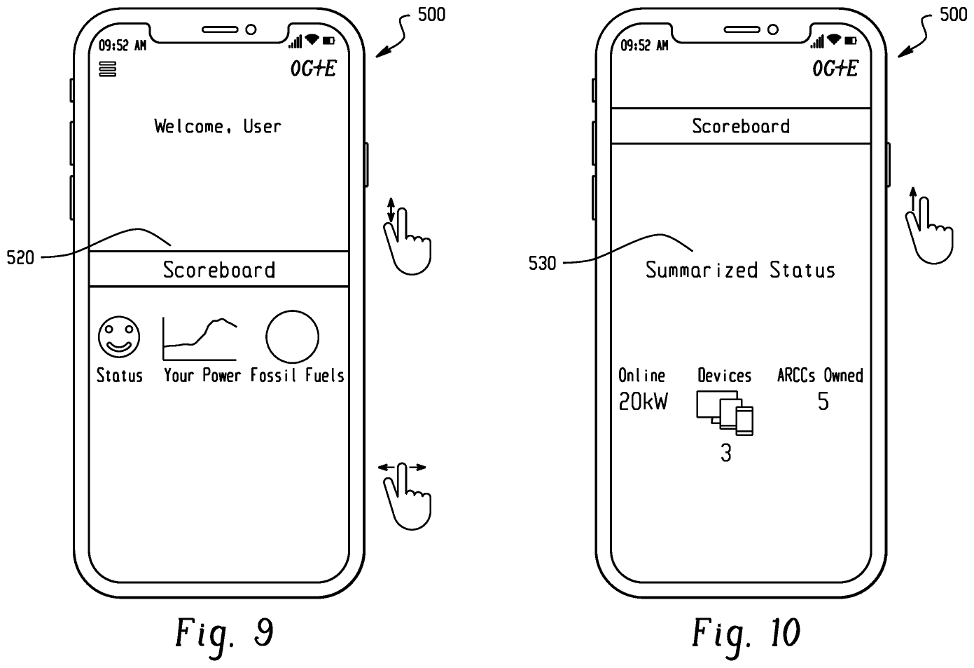

Operation 310 provides an option to track via metrics. For example, metrics may include kWh consumed, kW owned, greenhouse gases avoided or reduced, number of devices having associated ARCCs, ARCCs owned, kWh produced, etc. Examples of operation 310 are shown in FIGS. 9 and 10.

Operation 312 provides an option for personal user branding. This application operation may be used, for example, to personalize a user interface tile/widget for the buyer, provisioner, or community sponsor.

Operation 314 provides an option for a simple engaging experience, such as a scoreboard. For example, a scoreboard may be displayed on the application to present the environmental metrics (carbon, nox, sox, etc. . . . reduction) and the equivalent symbolic representations, such as number of trees planted or cars removed from the road. For instance, goals set by an individual or a virtual community that the individual is in may be displayed and compared against current status (see, e.g., FIGS. 9 and 10). The scoreboard 314 provides an option for the application to display customer impact on carbon reduction. For instance, the application may display the amount of carbon and other GHG reduced on account of an ARCC(s) (see, e.g., FIG. 9).

Operation 314 may also provide an option for a scoreboard tied to rewards. This operation may, for example, be tied to gamification. For instance, based on the number of ARCCs purchases, rewards attained, a placement style scoreboard (with username) may be provide to show individual, community, geo, and possibly global rank.

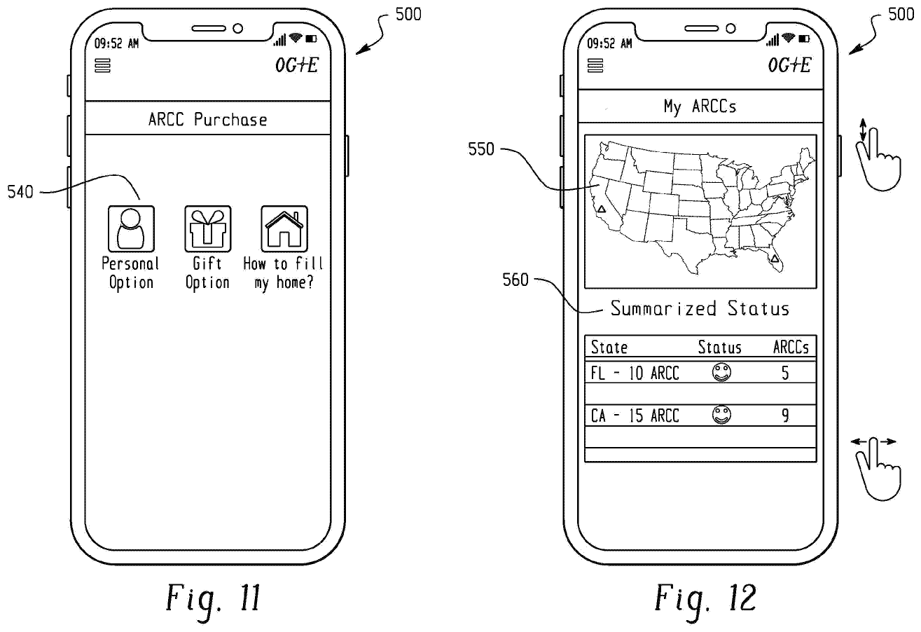

Operation 316 provides an option for the application to choose and display ARCC characteristics. This may include the user receiving a geo tag and/or visual of the renewable energy generator (e.g., solar panel) associated with an ARCC. For example, this operation may enable the user to know where the associated solar panel is located and provide a visual representation of the asset and how it is producing clean energy, for example as shown in FIG. 12. Operation 316 may also describe each ARCC when being purchased, such as by location, type of renewable, energy output, price, ARCC credential, etc., so that the purchaser has the ability to determine how they want to support renewable energy.

Operation 316 may provide the ability to choose the ARCC with the characteristic the entity desires; for example, type of renewable, location, price and reflecting in app with symbol, icon, shape, color, etc. Operation 316 may also provide an option for choosing the location of ARCCs. For example, companies could obtain ARCCs from the marketplace and then select where they would like their unbound ARCC purchases allocated to (i.e. geo, location, solar farm). There may, for example, be a ‘Starter’ price for obtaining an ARCC to make this work. With that, there may also be an associated transaction fee to locate the ARCCs at a desired location. The performance of solar generation will vary depending on the solar location and the transaction fees may adjust accordingly.

Operation 318 provides an option for displaying ARCC pricing across the market.

Operation 342 provides an option for branding ARCC consumption. This operation may be used, for example, to display ARCC inventory and the associated company, provisioner, manufacturer, or community on the ARCC UI token symbol.

Operation 344 provides a “REST” interface, for example to provide app functionality across all user devices.

Operation 346 provides an option to buy ARCCs. This can include a display of “purchase only” options. For example, this operation may be used to show options for a user to purchase for themselves, gift to others, and consider how to utilize ARCCs for other devices or their home. (See, e.g., FIG. 11).

Operation 348 provides an option for displaying aggregator/company reports, for example to indicate how the aggregator/company is contributing with all they are doing for users. This operation may, for example, provide an aggregated view by virtual community, company, provisioner, and user that reports the impact that they are making on the environment. The aggregated view may be pushed to the application user as a notification. (See, e.g., FIGS. 12 and 14).

Community module B 380 provides an option for including one or more application operations that are directed to a city, or other municipal entity, in which the ARCC service is provided. Cities may, for example, be defined in the application specification as a type of virtual community.

Operation 382 provides an option for branding of ARCCs by providers. This operation may be used, for example, to enable ARCCs that are provisioned by a company or manufacturer to be branded by that entity on the application.

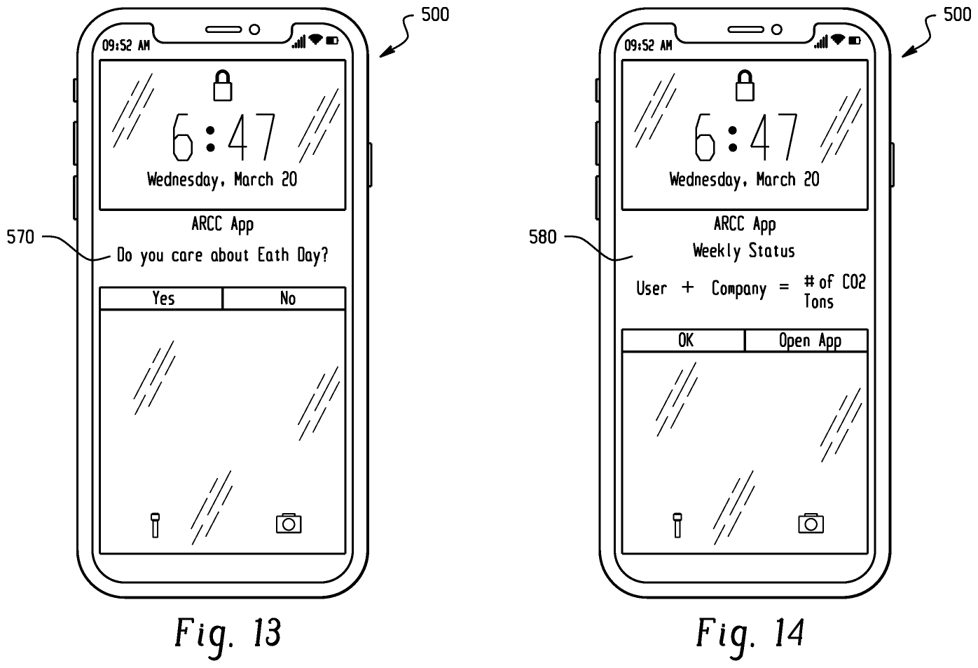

Operation 384 provides the option for push notifications. This operation may, for example, be used to notify communities, companies, or users on their mobile device about their GHG consumption, trees planted, cars removed or opportunities to do more, other environmental questions to engage, ties to target market, etc. In embodiments, push notifications may be provided as time initiated and event initiated notifications, for example as shown in FIGS. 13 and 14.

Operation 386 provides a community user interface. This can allow the application to be customizable for the needs of a city or community. The application also can provide an option for providing different application experiences for individual users vs. community owners. Similarly, the application provides an option for providing two groups a similar UI experience/interface. For example, application users may default to an individual user experience with a community experience added if the ARCCs are provisioned or if the user joins a virtual community out of choice or as a result of gift ARCCs.

Operation 388 provides an option for communicating community goals and status with a user community. For example, virtual communities (such as companies that provision ARCCs and cities) may have the ability to set goals and communicate the status of reaching those goals to community members.

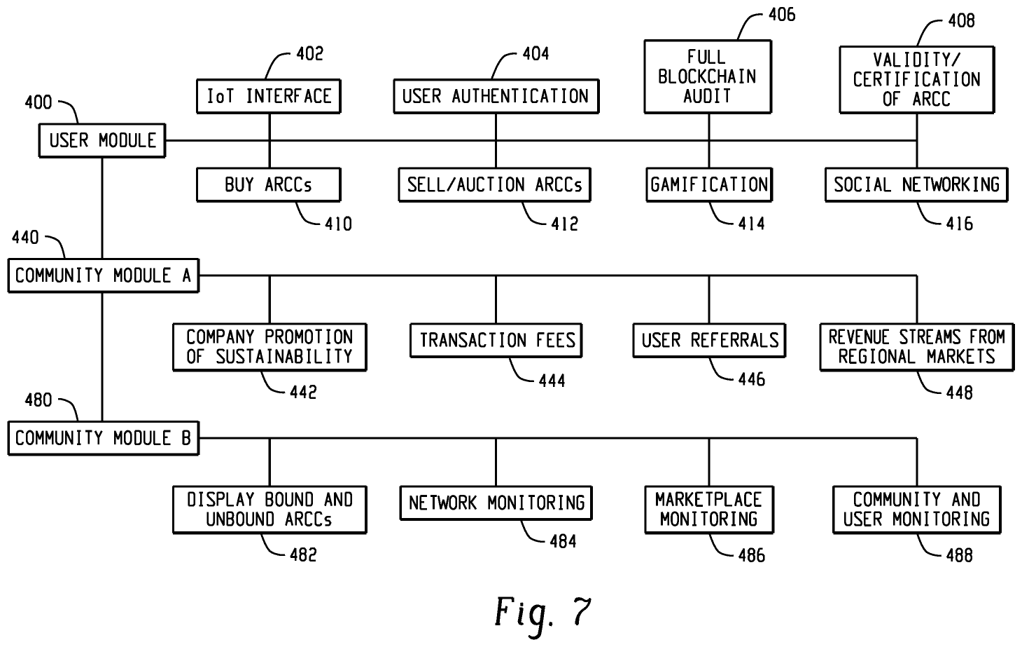

The user interface may also include additional operations not depicted in FIGS. 6-7. For example, the application may also be designed around the “rule of 3 on ‘clickability.’” This design rule requires that the application be configured such that no more than three clicks are ever required to access any particular application operation from a current screen, providing for limited or quick toggling in the app between information. The application may also display an ARCC tile or icon for the user interface and display the ARCC logo.

FIG. 7 is diagram depicting example elements and operations of a computer-implemented application(s) for creating, tracking, and assigning ARCCs. The elements and operations depicted in FIG. 7 may, for example, be included in a computer-implemented user interface application. The computer-implemented application(s) may, for example, include software executing on a special-purpose computer or device (such as a smart phone.) As illustrated in FIG. 7, some or all of the depicted application operations may be directed to different system entities, such as a user, depicted in the user module 400, of an electronic device associated with one or more ARCCs, or the community, depicted in the community modules 440, 480, which can be cities, companies, organizations, or other entities. In embodiments, different ARCC operations or user interfaces may be provided for each of these interested entities, with each different interface including some or all of the depicted elements and operations. For instance, in some embodiments, the application or user interface may be customized for a particular entity with a subset of the depicted elements and operations (and/or additional elements and operations). While each operation is depicted in a particular module, each operation may be configured for use in alternate modules as well. The operations shown in FIG. 7 may be combined into the application with operations shown in FIG. 6 and vice versa.

Operation 402 provides an option for using Internet-of-Things (IoT) technology to track energy generation associated with ARCCs. For example, users may have their ARCCs tied to SmartMeter technology at the solar panel farm sites and effectively track, in near real time, the amount of daily kWh generation from their ARCCs. For example, the application may display the number of ARCCs as Your Inventory=X amt. of kWh generated.

Operation 404 provides a user authentication option. User authentication may, for example, require login with a username and password. In embodiments, a two-factor authentication by registering a cell phone number, security question etc. may be required.

Operation 406 provides an option for a blockchain audit. This operation may be tied to Integrity of Purchase—providing the ability to trace the origin of individual or bundled ARCCs to their source/initial purchase/provision date, time, etc. The operation may, for example, be used in connection with the certification/validity of ARCC purchases.

Operation 408 provides an option for a display showing the validity, certification, and integrity of an ARCC purchase. For example, this operation may provide the ability to ‘tap’ on individual or bundled ARCCs in one's “inventory” and see date of purchase, time purchased, barcode, serial number verification, and a Green-e certification stamp. Operation 408 also provides an option for providing a certification process for ARCCs. For example, this operation may provide visibility into how long/where/when it takes Green-e to certify your bound our unbound ARCCs that end users purchase.

Operation 410 provides an option for a marketplace to buy ARCCs, for example with dollar averages/estimates. This may, for example, be part of a ‘Purchase Options’ portion of the ARCC User App.

Operation 412 provides an ARCC selling and auction option. This may, for example, be an option in a ‘Purchase Options’ portion of the ARCC app, providing the ability to sell your ARCCs to other end users, back to the community, other organization. The auction option may, for example, be an option in a ‘Purchase Options’ portion of the ARCC app, providing the ability to put your ARCCs “up for bid” or solar panel space up for attainment by another user. Daily kWh generation of certain ARCCs could play a factor in the operation gaining traction. This operation may also include an ARCC trade option. This may, for example, be an option in a ‘Purchase Options’ portion of the ARCC app, providing the ability to trade ARCCs with other end users, and may depend on bound vs. unbound, region, prices, potentially manufacturer, wireless provider, etc.

Operation 414 provides an option for providing games or other award-based operations relating to ARCCs. For example, the operation may provide the ability to add ARCC tokens into games as rewards and currency in the game, such as airline-type rewards where the more you buy the more you get. For example, a certain number of ARCCs gets you (insert reward). Next reward tier equals another number of ARCCs and you receive (insert reward). Possibly a member, silver, gold, and platinum tier ARCC user and associated rewards.

Operation 416 provides an option for social network badges and points. For example, the operation may provide the ability of end users, manufacturers, communities, provisioners, other organizations etc. to “share” their ARCC App User Profile credentials, status, # of ARCCs, achievements to high-traffic social media outlets (e.g., Facebook, Twitter, Instagram, LinkedIn).

Operation 442 provides an option for individual/company promotion of sustainability. For example, the operation may be tied to in-app activity as well as timed/event-driven push notifications stemming from the ARCC application. End users, communities etc. may be able to promote their level of sustainability. This could encourage further ARCC purchases and greater contribution to individual/community goals/initiatives etc.

Operation 444 provides a transaction fee option. This may, for example, require a nominal amount of money to process a sell, auction, or trade of an ARCC. In embodiments, not all ARCCs will carry the equivalent monetary value.

Operation 446 provides an option for user referrals. This operation may, for example be located within the in-app functionality as a button or trigger to ‘Share the ARCC’ via a prefabricated notification (email, text, social media post) inviting others (directly or indirectly) to download ARCC and start contributing today.

Operation 448 provides an option for identifying revenue streams from regional markets. The operation may, for example, be used to display the revenue that the renewable energy generator receives for the renewable energy sold into the RTO.

Operation 482 provides an operation for displaying bound vs. unbound ARCCs. A unbound ARCC is an ARCC that is purchased by a company or community but not provisioned to a assigned electronic device, facility, product or process. A bound ARCC is assigned to an electronic device, facility, product or process.

Operation 484 provides an option for network monitoring of the ARCCs to display the location and characteristic information of ARCCs across the network.

Operation 486 provides an option for marketplace monitoring to display available ARCCs and recent transactions.

Operation 488 provides an option for community and user monitoring to display ARCC profiles of various members of the community including companies and users.

The application may include additional operations not depicted in FIGS. 6-7. The application may provide an operation for a retail presentation and user education. For example, the operation may provide “Learn More” functionality within the app for all users to receive and obtain content to better understand the value behind investing in ARCCs and renewable energy. The application may provide an option for transferring ARCCs. This operation may provide the ability for users to transfer ARCCs to various electronic device, facility, product or process, and other users/family members, etc. The operation may, for example, also be utilized to enable transferability between Smart Devices to fulfill green energy attainment.

The application may provide an operation for ARCC pricing. The operation may, for example, provide the ability to price ARCCs differently base on ARCC characteristics, including price, location, type, payback operation and ownership/business investment. The application may provide an operation for receiving awards for ARCCs. For example, if an end user, manufacturer, community, provisioner, or other organization purchases/achieves attainment of x # of ARCCs, this may equates to a prize/rewards/membership operations of attainment/etc. The application may provide an operation to tie ARCCs to a device or user app. For example, the operation may provide the ability to have provisioned ARCCs tied to the ARCC User App and connected to a device. A first approach may be in cellular devices. Other “Smart Devices” could include: tablets, watches, laptops, TVs, ceiling fans, light fixtures, washers, dryers, cars, etc.

The application may provide an operation for a multi-branded ARC token. For instance, the operation may provide the ability to brand an ARCC with more than one company in case a manufacture and a retailer wants to buy and provision ARCCs together. The operation may be used to provide partnered branding. The user interface may provide an operation for providing tiers of ARCC purchasing (e.g., bundles). For example, end consumers may have the option to either purchase singular or bundles (blocks/packs) of ARCCs through the user app.

The application may provide an operation for providing ecosystems within an ecosystem, provide an operation for providing an ARCC marketplace and sub-marketplace. For example, this operation may provide the ability for users to purchase generic ARCCs a-la-carte and allocate them to a location from the open ARCC marketplace, and/or the ability to “join/follow” communities and purchase ARCCs through those respective communities.

The application may provide an option for providing a partner extension. For example, with a Blockchain Network/Audit, having a business-grade, private, permissioned-based ledger would allow for members of the Network to extend invitations to others—further extending the Network and the overall goals/missions of ‘Why ARCCs’. The application may also provide an option for displaying tower power consumption.

The application may provide an option for tying an app operating system (such as iOS) with screentime. For example, the operation may be associated with push notifications, Time and Event-Driven Banner Notifications. Regardless of app utilization, users may receive a weekly notification of individual, community, “look how much you're saving with ARCCs” performance.

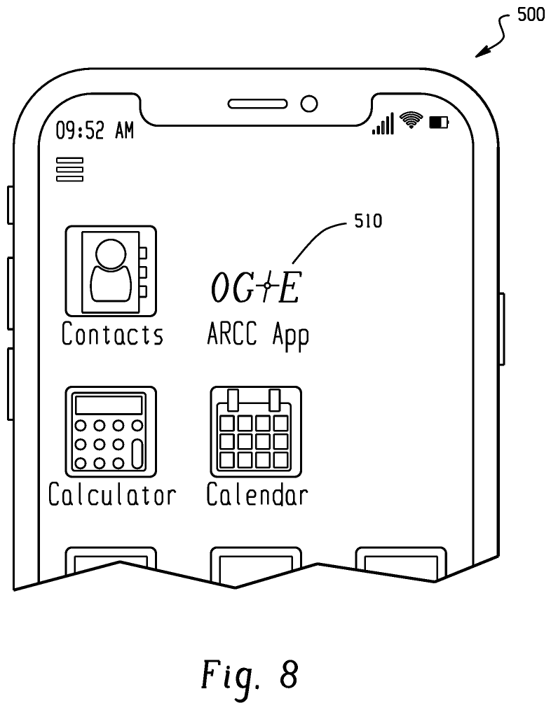

FIGS. 8-14 further illustrate example elements and operations of a computer-implemented application(s) (such as a user interface application) for creating, tracking, assigning, advertising, promoting, and gamifying ARCCs. FIG. 8 illustrates an example of tiles, icons, widgets, etc. that may be displayed on a phone's main screen and includes ARCC application 510. As shown the tiles/icons/widgets may include brands and logos, and may also display summarized information that can be customized (e.g., personal, wireless provider, municipality, or city.) Clicking on a user interface time/icon/widget launches the ARCC application 510.

FIG. 9 shows an example “main page” for an ARCC application 510. As shown, the “main” application page may include a top section that displays a personalized ad insertion for the user, cellular provider, cell phone manufacturer, etc. A center section of the page may display a scoreboard 520 for a renewable energy generator (e.g., solar panel or wind turbine) status (e.g., as an emoticon), along with the power output of virtual panels, fossil fuel offset, and/or gas/carbon offset. Swiping left/right on the UI may, for example, show trees representing total green energy, trucks representing a total amount of pollution offset, and power plants representing the total amount of fossil plants offset. Swiping up on the UI may display community information, such as the name of a city associated with an ARCC initiative and associated information. Swiping down on the UI may display aggregation level data.

FIG. 10 shows a further example of a “main page” for the ARCC application 510. In this example, a section of the UI displays summarized ARCC status information 530, such as a total power output in kilowatts, an icon of devices that are using green energy (e.g., phone, laptop, tablet), and a total number of ARCCs owned by the user.

FIG. 11 shows an example of a purchase user interface (UI) 540 for an ARCC app. As illustrated, the UI may include a personal option interface, for example, to allow users to buy more ARCCs for themselves or to “top up” new devices (e.g., television, household appliance, etc.). The UI may also include a gift option interface to enable a user to purchase ARCCs for family, community, municipality, city, etc.

FIG. 12 shows an example of an ARCC status page for an ARCC app. As shown, an ARCC status UI may, for example, include a map 550 with ‘pins’ that show where renewable energy generators (e.g., solar panels, wind turbines, etc.) associated with the user's ARCCs are located. For example, when a user selects a pin in the map, the UI may show summary information below the map, such as the panel output, the solar panel status (e.g., a happy face emoticon). The UI may also display the total number of ARCCs the user owns per location.

FIGS. 13 and 14 show examples of push notifications 570, 580 for the ARCC application 510. As shown, notifications related to a user's ARCCs may be pushed to the UI, for example being displayed on a device lock screen or in a banner or splash screen.

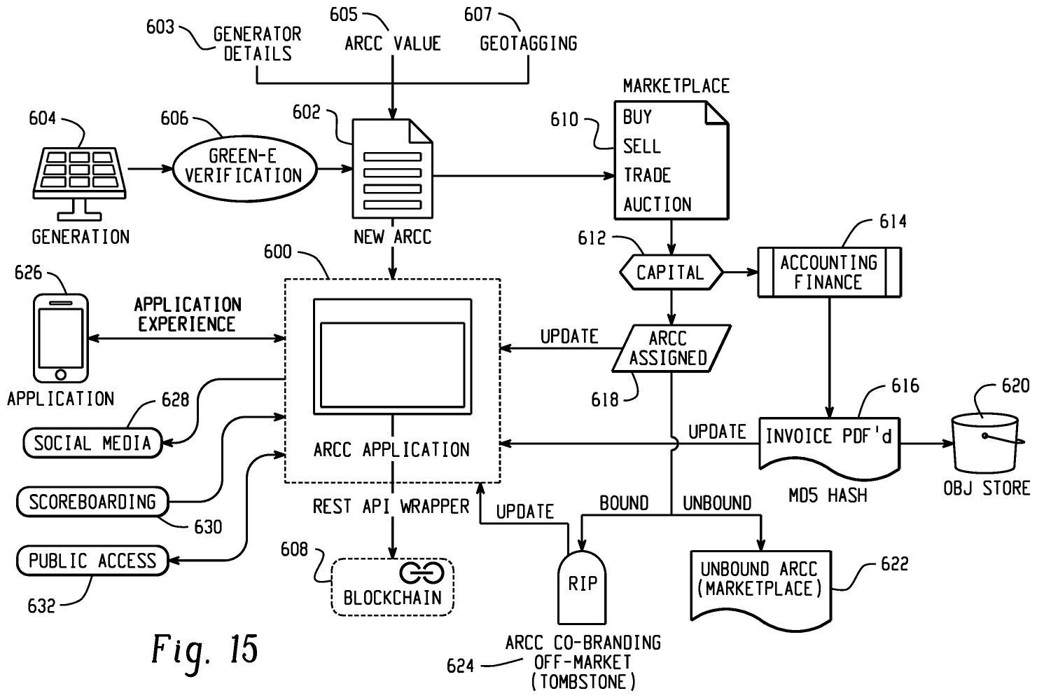

FIG. 15 is a block diagram of an example system for providing a computer-based (e.g., online) market where additional renewable capacity credits may be provisioned, bought, sold, and traded (referred to herein as an ARCC system) on the marketplace 610. The ARCC system includes an ARCC application 600, for example, as described above with reference to FIGS. 6-14. Also illustrated are various elements and operations of the ARCC system, which may be included as part of the ARCC application 600 or, alternatively, may be included in software executing on a special-purpose computer or systems that interface with the ARCC application 600.

As illustrated, each new ARCC 602 created in the ARCC system is linked to the installation of a renewable energy generation source 604, such as a solar panel, wind turbine, or other renewable energy source. The installation and continued operation of the renewable energy generation source 604 may be verified by an environmental verification service 606, such as the Green-e® service provided by the Center for Resource Solutions, in order to authenticate and validate ARCCs placed into the market. As shown, a new ARCC 602 generated in the system may identify details 603 of the associated renewable energy generator (e.g., location, energy production, etc.), a value of the ARCC 605, and a location 607 (e.g., geotagging) of the associated renewable energy generator.

FIG. 15 further illustrates that block-chain technology 608 may be used to verify that each ARCC is traceable to a watt of additional renewable energy capacity and that the energy reduced is traceable to greenhouse gases. As described above with reference to FIG. 1, block-chain technology 608 may also be used in connection with the verification service 606 to authenticate and validate new ARCCs 602 placed into an ARCC marketplace 610. Capital 612 can transfer between the buyer and seller of the ARCC and the ARCC can be assigned 618 and update the ARCC application 600. The ARCC may also be unbound and sent to the unbound ARCC marketplace 622 to be bought and sold, or it may be bound and sent to the ARCC co-branding off-market (tombstone) 624, which subsequently updates the ARCC application 600.

The ARCC application 600 may also interface with (or include) one or more accounting applications 614, 616, 620. For example, in one embodiment, the ARCC application 600 may be configured to interface with Quickbooks software provided by Intuit Inc. FIG. 14 also illustrates that the ARCC application 600 may provide (or access) one or more social media 628, scoreboarding 630, and public access operation 632, for example as described above with reference to FIGS. 6-14, and may operate as an app on an electronic device operating system 626, such as iOS or Android.

The methods and systems described herein may be implemented on many different types of special-purpose processing devices by program code comprising executable software program instructions. The software program instructions may include source code, object code, machine code, or any other stored data that is operable to cause a processing system to perform the methods and operations described herein and may be provided in any suitable language such as C, C++, C #, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed:

1. A computer-implemented method for providing additional renewable capacity credits, comprising:
determining an energy capacity of the renewable energy source;
converting the energy capacity of the renewable energy source into one or more additional renewable capacity credits;
using a computer-implemented block-chain distributed ledger system to associate the one or more additional renewable capacity credits with the installed renewable energy source; and
providing the one or more additional renewable capacity credits for purchase on a computer-implemented marketplace to offset energy consumption for a particular energy-consuming device, location, or process.

2. The computer-implemented method of claim 1, wherein the block-chain distributed ledger system coordinates information corresponding to the one or more additional renewable capacity credits between renewable energy providers, manufacturers, retailers, and users.

3. The computer-implemented method of claim 1, wherein the one or more additional renewable capacity credits is matched with the particular energy-consuming device.

4. The computer-implemented method of claim 3, wherein the matched one or more additional energy capacity credits is converted into an amount of CO₂ reduction.

5. The computer-implemented method of claim 4, wherein the amount of CO₂ reduction is converted into a number of trees planted, cars eliminated, and fossil fuel plants eliminated.

6. The computer-implemented method of claim 1, wherein an additional renewable capacity credit application is used to organize additional renewable energy credit information.

7. The computer-implemented method of claim 6, wherein the additional renewable capacity credit application includes a user interface to display a scoreboard to show the status of the renewable energy source corresponding to the one or more additional renewable energy credits.

8. The computer-implemented method of claim 6, wherein the additional renewable capacity credit application includes a user interface to display a scoreboard of one or more statistics associated with the one or more additional renewable capacity credits as a notification or popup.

9. The computer-implemented method of claim 6, wherein the additional renewable capacity credit application includes a purchasing option to purchase additional renewable capacity credits for a user and purchase additional renewable capacity credits for the user to gift to someone else.

10. The computer-implemented method of claim 6, wherein the additional renewable capacity credit application interfaces with social media to allow one or more users to see and display information corresponding to the one or more advanced renewable capacity credits to the one or more users social networks.

11. A computer-implemented method for providing additional renewable capacity credits, comprising:
determining an energy capacity of the renewable energy source;
converting the energy capacity of the renewable energy source into one or more additional renewable capacity credits; and
providing the additional renewable capacity credits to offset energy consumption for a particular energy-consuming device, location, or process.

12. The computer-implemented method of claim 11, wherein the one or more additional renewable capacity credits is matched with the particular energy-consuming device.

13. The computer-implemented method of claim 12, wherein the matched one or more additional renewable capacity credits is converted into an amount of CO₂ reduction.

14. The computer-implemented method of claim 13, wherein the CO₂ reduction is converted into a number of trees planted, cars eliminated, and fossil fuel plants eliminated.

15. The computer-implemented method of claim 11, wherein an additional renewable capacity credit application is used to organize additional renewable capacity credit information.

16. The computer-implemented method of claim 15, wherein the additional renewable capacity credit application includes a user interface to display a scoreboard to show the status of the renewable energy source corresponding to the one or more additional renewable capacity credits.

17. The computer-implemented method of claim 15, wherein the additional renewable capacity credit application includes a user interface to display a scoreboard to show one or more statistics associated with the one or more additional renewable capacity credits as a notification or popup.

18. The computer-implemented method of claim 15, wherein the additional renewable capacity credit application includes a purchasing option to purchase additional renewable capacity credits for a user and purchase additional renewable capacity credits for a user to gift to someone else.

19. The computer-implemented method of claim 15, wherein the additional renewable capacity credit application interfaces with social media to allow one or more users to see and display information corresponding to advanced renewable capacity credits to the one or more users' social networks.

20. The computer implemented method of claim 15, wherein the additional renewable capacity credit application is configured to interact with internet-of-things technology to track energy generation associated with ARCCs.
